(19) United States
(12) Patent Application Publication
(10) Pub. No.: US 2026/0176899 A1
(43) Pub. Date: Jun. 25, 2026

(54) Handle System, Vehicle Comprising Same and Method for Controlling Handle System

(71) Applicant: Illinois Tool Works Inc., Glenview, IL (US)

(72) Inventor: Wenquan Sha, Shanghai (CN)

(21) Appl. No.: 19/427,139

(22) Filed: Dec. 19, 2025

(30) Foreign Application Priority Data
Dec. 23, 2024 (CN) 202411906809.0
Dec. 17, 2025 (CN) 202511912337.4

(51) Int. Cl. E05B 85/10; E05B 85/16

(52) U.S. Cl. CPC E05B 85/107; E05B 85/16

(57) ABSTRACT

The present disclosure provides a handle system including a handle seat, a handle body, a driving device, a position sensing device, a sensed member and a control device. The handle body is mounted to the handle seat and movable relative to the handle seat between a retracted position, a first deployed position and a second deployed position. The driving device is configured to drive the handle body to deploy from the retracted position to the first deployed position and to retract from the first deployed position to the retracted position. The position sensing device includes at least two position sensors positioned on one of the handle seat and the handle body and spaced apart in a movement direction of the handle body. The sensed member is positioned on the other of the handle seat and the handle body and has a sensed area. The sensed member is configured such that when any one of the at least two position sensors enters the sensed region, the sensed member is detected by the position sensor entering the sensed region. The control device is communicatively connected to the position sensing device, the driving device, and the electronic lock device.

### RELATED APPLICATIONS

The present application claims the benefit of Chinese Patent Application Nos. 202411906809.0, filed Dec. 23, 2024, and 202511912337.4, filed Dec. 17, 2025, each titled “Movable Part for Vehicle,” the contents of which are hereby incorporated by reference.

### TECHNICAL FIELD

The present disclosure relates to a handle system, and in particular to a handle system for a door of a vehicle, a vehicle comprising the handle system and a method for controlling the handle system.

### BACKGROUND

A door of a vehicle is provided with a handle, which includes a handle seat secured to sheet metal of the door and a handle body movable relative to the handle seat. In some conventional flush handles, when not in use, a driving device drives the handle body to retract relative to the handle seat, so as to make an outer surface of the handle body to be substantially flush with the door of the vehicle. When it is required to open the door from the outside of the vehicle, the driving device first drives the handle body to deploy relative to the handle seat, enabling an operator to pull the handle body from the outside to unlock an electronic lock device of the door of the vehicle, thereby opening the door of the vehicle.

### SUMMARY OF THE DISCLOSURE

The present disclosure relates generally to a handle system, substantially as illustrated by and described in connection with at least one of the figures, as set forth more completely in the claims.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a handle system according to an embodiment of the present disclosure, with a handle body of the handle system in a retracted position.

FIG. 1B is a top view of the handle system shown in FIG. 1A.

FIG. 2A is a perspective view of the handle system shown in FIG. 1A, with the handle body of the handle system in a first deployed position.

FIG. 2B is a top view of the handle system shown in FIG. 2A.

FIG. 3A is a perspective view of the handle system shown in FIG. 1A, with the handle body of the handle system in a second deployed position.

FIG. 3B is a top view of the handle system shown in FIG. 3A.

FIG. 3C is a perspective view of the handle system shown in FIG. 1A, with the handle body of the handle system in another second deployed position.

FIG. 3D is a top view of the handle system shown in FIG. 3C.

FIG. 4A is a structural perspective view of a position sensing device shown in FIG. 1A.

FIG. 4B is an exploded view of the position sensing device shown in FIG. 4A.

FIGS. 5A-5D are simplified schematic views showing relative positions of a handle seat and the handle body during movement of the handle body of the handle system according to an embodiment of the present disclosure.

FIGS. 6A-6C are simplified schematic views showing relative positions of the handle seat and the handle body during movement of the handle body of the handle system according to another embodiment of the present disclosure.

FIG. 7 is a connection block diagram of a control device, the position sensing device, a driving device and an electronic lock device in FIG. 1A.

FIG. 8 is a simplified circuit diagram of a circuit board in FIG. 4A.

FIG. 9 is a structural block diagram of the control device of the handle system in FIG. 1A.

FIG. 10 is a schematic view of a vehicle including the handle system shown in FIG. 1A.

FIG. 11 illustrates a flowchart of a method for controlling the handle system shown in FIG. 1A.

FIG. 12 illustrates step 1162 in FIG. 11.

FIG. 13 illustrates step 1163 in FIG. 11.

### DETAILED DESCRIPTION

Various specific embodiments of the present disclosure will be described below with reference to the drawings which form part of this specification. It should be understood that although the terms indicating directions, such as “front”, “rear”, “upper”, “lower”, “left”, “right”, “inner”, and “outer” are used in the present disclosure to describe structural parts and elements in various examples of the present disclosure, these terms are used herein only for ease of illustration and are determined based on the exemplary orientations shown in the accompanying drawings. Since the arrangements in the embodiments disclosed in the present disclosure may be in various directions, these terms indicating directions are only illustrative and should not be considered as limitations.

The present disclosure provides, according to a first aspect, a handle system for a door of a vehicle having an electronic lock device. The handle system includes a handle seat, a handle body, a driving device, a position sensing device, a sensed member and a control device. The handle body is mounted to the handle seat and movable relative to the handle seat between a retracted position, a first deployed position and a second deployed position. The driving device is configured to drive the handle body to deploy from the retracted position to the first deployed position and to retract from the first deployed position to the retracted position. The position sensing device includes at least two position sensors positioned on one of the handle seat and the handle body and spaced apart in a movement direction of the handle body. The sensed member is positioned on the other of the handle seat and the handle body and has a sensed area. The sensed member is configured such that when any one of the at least two position sensors enters the sensed region, the sensed member is detected by the position sensor entering the sensed region. The control device is communicatively connected to the position sensing device, the driving device, and the electronic lock device. The control device is configured to determine whether the handle body reaches the retracted position, the first deployed position or the second deployed position depending on whether the at least two position sensors detect the sensed member, to control the driving device to stop driving the handle body to retract when determining that the handle body reaches the retracted position, to control the driving device to stop driving the handle body to deploy when determining that the handle body reaches the first deployed position, and to control the electronic lock device to unlock when determining that the handle body reaches the second deployed position.

In some embodiments, the at least two position sensors include a first position sensor and a second position sensor. The second position sensor is positioned outermost and the first position sensor is positioned innermost in the movement direction of the handle body. When the handle body reaches the retracted position, the second position sensor detects the sensed member. When the handle body reaches the first deployed position, the first position sensors detects the sensed member. When the handle body reaches the second deployed position, none of the at least two position sensors detects the sensed member.

In some embodiments, the control device determines that the handle body reaches the retracted position based on a detection signal from the second position sensor, determines that the handle body reaches the first deployed position based on a detection signal from the first position sensor, and determines that the handle body reaches the second deployed position based on detection signals from both the first position sensor and the second position sensor.

In some embodiments, the at least two position sensors further include a third position sensor. The third position sensor is positioned between the first position sensor and the second position sensor. The control device determines that the handle body reaches the retracted position based on a detection signal from the second position sensor, determines that the handle body reaches the first deployed position based on a detection signal from the first position sensor, and determines that the handle body reaches the second deployed position based on detection signals from all of the first position sensor, the second position sensor and the third position sensor.

In some embodiments, the position sensors are Hall sensors. The sensed member is a magnet, and the sensed area is a magnetic field of the magnet.

In some embodiments, the Hall sensors are switch-type Hall sensors.

In some embodiments, the position sensing device further includes a circuit board, the at least two position sensors are integrated on the circuit board, and the circuit board has a power supply terminal for connecting the at least two position sensors to a power supply and signal output terminals for connecting the at least two position sensors to the control device.

In some embodiments, the position sensing device further includes a housing. The circuit board is accommodated and retained in the housing.

In some embodiments, the handle system further includes a light module. The light module is integrated on the circuit board and turned on or off based on the position of the handle body.

In some embodiments, the sensed member is positioned on an inner wall of the handle seat, and the at least two position sensors are encapsulated inside the handle body.

In some embodiments, the handle body has a grip portion, and a first support post and a second support post on two opposite sides of the grip portion. A travel distance of the second support post is greater than a travel distance of the first support post during movement from the retracted position to the second deployed position. The position sensing device is encapsulated inside the second support post of the handle body.

The present disclosure provides, according to a second aspect, a vehicle including a door, an electronic lock device and a handle assembly as aforementioned. The electronic lock device is positioned on the door and configured to lock or unlock the door.

The present disclosure provides, according to a third aspect, a method for controlling a handle system. The handle system includes a sensed member, at least two position sensors, a handle body, a handle seat, and a driving device. The sensed member is positioned on one of the handle body and the handle seat, and the at least two position sensors is positioned on the other of the handle body and the handle seat. The method includes: detecting a relative position of the sensed member relative to the at least two position sensors via the at least two position sensors; determining a position of the handle body relative to the handle seat depending on detection signals obtained from the at least two position sensors; and controlling the driving device to stop driving the handle body to retract, stop driving the handle body to deploy, or controlling an electronic lock device to unlock, depending on the position of the handle body relative to the handle seat.

In some embodiments, the step of determining the position of the handle body relative to the handle seat based on the detection signals obtained from the at least two position sensors includes: when a first position sensor, positioned innermost in a movement direction of the handle body among the at least two position sensors, detects the sensed member, determining that the handle body reaches a first deployed position; when a second position sensor, positioned outermost in the movement direction of the handle body among the at least two position sensors, detects the sensed member, determining that the handle body reaches a retracted position; and when none of the at least two position sensors detects the sensed member, determining that the handle body reaches a second deployed position.

In some embodiments, the step of controlling the driving device to stop driving the handle body to retract, stop driving the handle body to deploy, or controlling the electronic lock device to unlock based on the position of the handle body relative to the handle seat includes: when the handle body reaches the first deployed position, stopping driving the handle body to deploy; when the handle body reaches the retracted position, stopping driving the handle body to retract; and when the handle body reaches the second deployed position, controlling the electronic lock device to unlock.

The handle system of the present disclosure can accurately indicate that the handle body is in the retracted position, the first deployed position or the second deployed position relative to the handle seat by providing the position sensing device and sensed member, which cooperatively work, on the handle seat and the handle body. Based on the position of the handle body, the control device of the handle system can control the driving device, such that the driving device stops driving the handle body when the handle body is moved to the retracted position and the first deployed position, and the control device can control the unlocking of the electronic lock device when the handle body is moved to the second deployed position.

Other objects and advantages of the present disclosure will become apparent from the description below with reference to the accompanying drawings, and they may assist in gaining a comprehensive understanding of the present application.

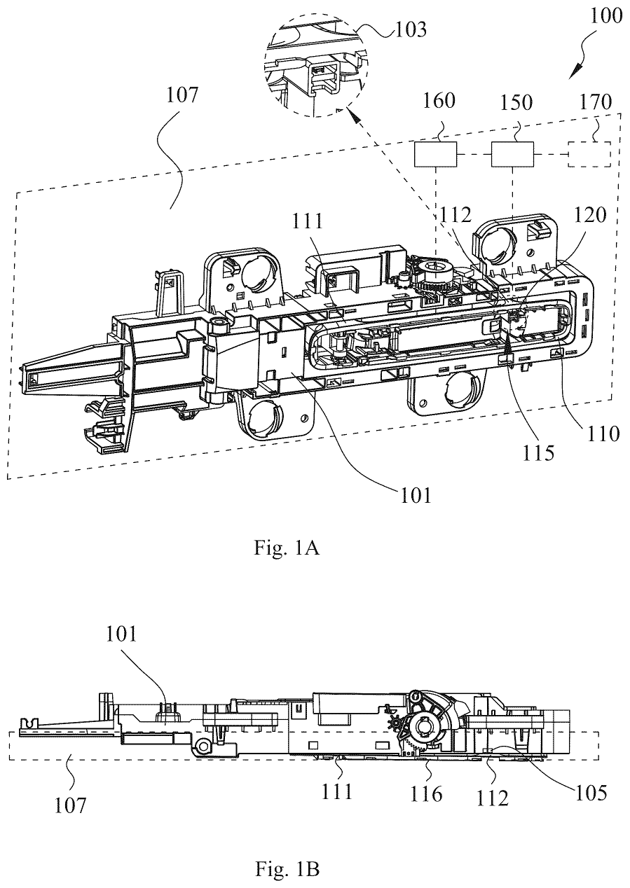

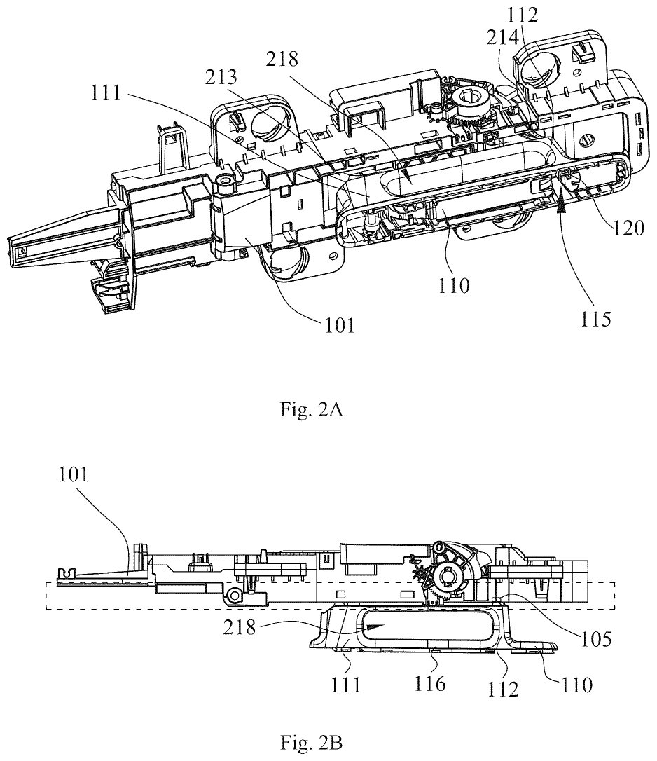

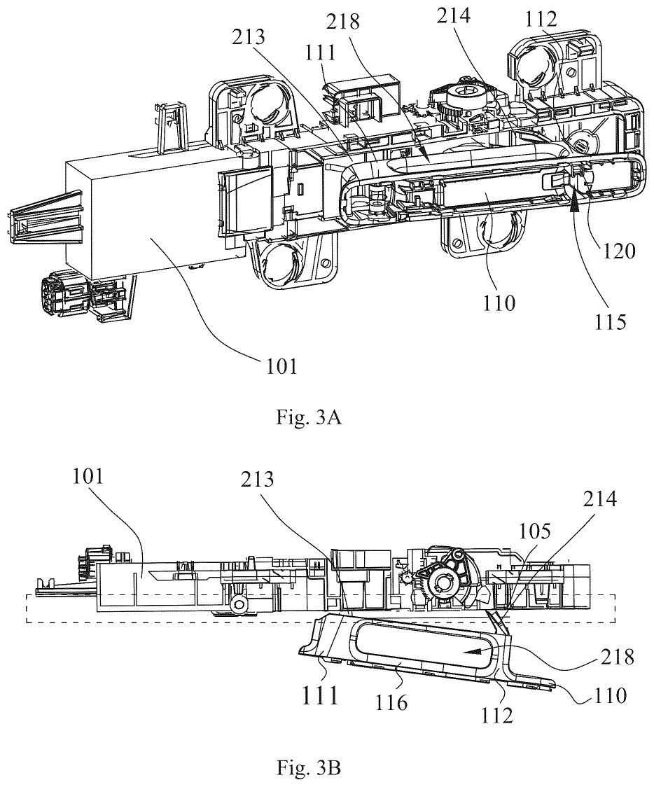

FIGS. 1A to 3D illustrate a positional relationship of a handle body 110 and a handle seat 101 of a handle system 100 according to an embodiment of the present disclosure, with the handle body 110 in different positions. In FIGS. 1A and 1B, the handle body 110 is in a retracted position. In FIGS. 2A and 2B, the handle body 110 is in a first deployed position. In FIGS. 3A and 3B, the handle body 110 is in an exemplary second deployed position. In FIGS. 3C and 3D, the handle body 110 is in another exemplary second deployed position.

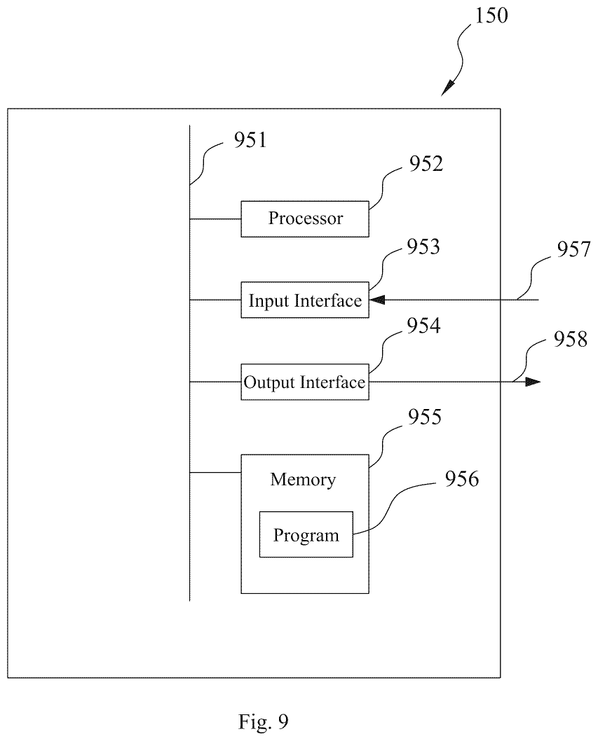

As shown in FIGS. 1A-3D, the handle system 100 is used for a door 107 of a vehicle 1060 provided with an electronic lock device 170 (see FIG. 10). The electronic lock device 170 is positioned on the door 107 and configured to lock or unlock the door 107. When the electronic lock device 170 is locked, the door 107 cannot be opened. When the electronic lock device 170 is unlocked, the door 107 can be opened.

The handle system 100 includes the handle seat 101, the handle body 110, a driving device 160, and a control device 150. The handle seat 101 is secured to the door 107 of the vehicle. The handle body 110 is mounted to the handle seat 101, and can move relative to the handle seat 101 between the retracted position, the first deployed position and the second deployed position. The control device 150 is communicatively connected to the driving device 160 and the electronic lock device 170 to control the driving device 160 to drive the handle body 110 to move and to control the unlocking of the electronic lock device 170.

The handle body 110 is mounted to the handle seat 101, for example, via a linkage mechanism. The linkage mechanism is connected to the driving device 160, allowing the driving device 160 to drive the linkage mechanism to move, thereby driving the handle body 110 to deploy from the retracted position to the first deployed position and to retract from the first deployed position to the retracted position. In the illustrated embodiment, the linkage mechanism includes a first link 213 and a second link 214. In some embodiments, the driving device 160 is an electric actuator. Those skilled in the art should understand that the linkage mechanism may be designed as any structure according to specific requirements, as long as the driving device 160 can drive the handle body 110 to reciprocate between the retracted position and the first deployed position.

The handle body 110 is moved from the first deployed position to the second deployed position by a pulling force applied by an operator from the outside of the handle system 100. In this embodiment, the handle body 110 is substantially in the shape of a hollow square frame, with the middle portion forming an accommodating cavity 218 for operation by the operator's hand. The handle body 110 has a grip portion 116 on a front side of the accommodating cavity 218. The handle body 110 is provided with a first support post 111 and a second support post 112 respectively on two opposite sides (the left side and the right side as shown in FIG. 2B) of the grip portion 116. In the illustrated embodiment, the first link 213 connects the first support post 111 of the handle body 110 to an inner sidewall of the handle seat 101, and the second link 214 connects the second support post 112 of the handle body 110 to the inner sidewall of the handle seat 101. As the operator's hand extends into the accommodating cavity 218, the operator's hand can hold the grip portion 116 to apply a pulling force to the handle body 110, such that the handle body 110 is moved from the first deployed position to the second deployed position under the action of the external pulling force applied by the operator.

In the illustrated embodiment, the handle system 100 further includes an elastic component, such as a torsion spring (not shown), positioned on the handle seat 101. The torsion spring is operatively coupled to the second link 214. After the handle body 110 is released by the operator, the handle body 110 in the second deployed position can be moved to the first deployed position by means of a restoring force provided by the torsion spring. In this way, the handle body 110 can reciprocate between the first deployed position and the second deployed position under the action of the external pulling force applied by the operator and the restoring force of the torsion spring.

When the handle body 110 is in the retracted position as shown in FIGS. 1A and 1B, the handle body 110 is generally accommodated inside the handle seat 101, and an outer surface of the handle body 110 is substantially flush with an outer surface of the handle seat 101. When the handle seat 101 is mounted to the door 107 of the vehicle, the outer surface of the handle body 110 can also be substantially flush with an outer surface of the door 107. Therefore, the handle body 110 can be visually concealed within the door 107 of the vehicle.

When the handle system 100 receives a driving signal (e.g., a driving signal indicating door opening, for example, a car key approach signal or a car key unlock signal), the control device 150 controls the driving device 160 to drive the handle body 110 substantially in parallel, such that the handle body 110 is translationally deployed from the retracted position shown in FIGS. 1A and 1B to the first deployed position as shown in FIGS. 2A and 2B.

When the handle body 110 reaches the first deployed position as shown in FIGS. 2A and 2B, the control device 150 controls the driving device 160 to stop driving the handle body 110 to deploy. In the first deployed position, the outer surface of the handle body 110 is substantially parallel to the handle seat 101, and the first support post 111 and the second support post 112 are moved relative to the handle seat 101 by substantially equal movement distances. The handle body 110 extends outwardly relative to the handle seat 101 to expose the accommodating cavity 218 and the grip portion 116 of the handle body 110, enabling the operator to extend his/her hand into the accommodating cavity 218 and hold the grip portion 116, thereby pulling the handle body 110.

When the operator pulls the handle body 110, the external pulling force drives the handle body 110 to perform a rotational movement, substantially with an inner end of the first support post 111 connected to the first link 213 as a pivot point. The second support post 112 of the handle body 110 is rotated away from the handle seat 101. The second link 214 of the linkage mechanism moves outwardly with the second support post 112 until the handle body 110 is rotated to the second deployed position as shown in FIGS. 3A and 3B. In this process, the torsion spring builds up the restoring force.

When the handle body 110 reaches the second deployed position as shown in FIGS. 3A and 3B, the control device 150 controls the unlocking of the electronic lock device 170 on the door 107 of the vehicle, enabling the operator to continue to pull the handle body 110 so as to open the door 107 of the vehicle. In this process, the torsion spring further builds up the restoring force.

When the operator stops pulling the handle body 110, the handle body 110 returns to the first deployed position shown in FIGS. 2A and 2B under the action of the restoring force of the torsion spring. When the handle system 100 receives a driving signal (e.g., a signal for door closing operation) again, the control device 150 controls the driving device 160, driving the handle body 110 to translate toward the retracted position by means of the linkage mechanism. When the handle body 110 is retracted to the retracted position as shown in FIGS. 1A and 1B, the control device 150 stops driving the handle body to retract.

In this way, the handle body 110 of the handle system 100 can move between the retracted position, the first deployed position and the second deployed position.

In some emergency situations, the handle body 110 may rotate directly from the retracted position to another second deployed position. This second deployed position is different from the second deployed position mentioned above, but the two second deployed positions are both positions where the unlocking of the electronic lock device 170 can be triggered. In this case, when the handle body 110 is in the retracted position as shown in FIGS. 1A and 1B, the operator can press the side of the handle body 110 close to the first post 111, to cause the side of the handle body 110 close to the second post 112 to extend outwardly. After the accommodating cavity 218 is exposed, the operator forcedly pulls the grip portion 116 to rotate the handle body 110 directly from the retracted position as shown in FIGS. 1A and 1B to the second deployed position as shown in FIGS. 3C and 3D. When the handle body 110 is in the second deployed position as shown in FIGS. 3C and 3D, the control device 150 can also control the unlocking of the electronic lock device 170 on the door 107 of the vehicle, enabling the operator to pull the door 107 of the vehicle open.

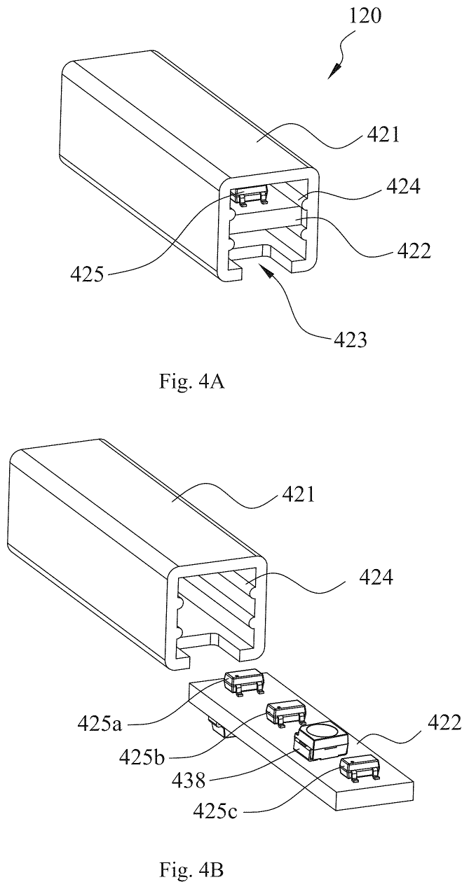

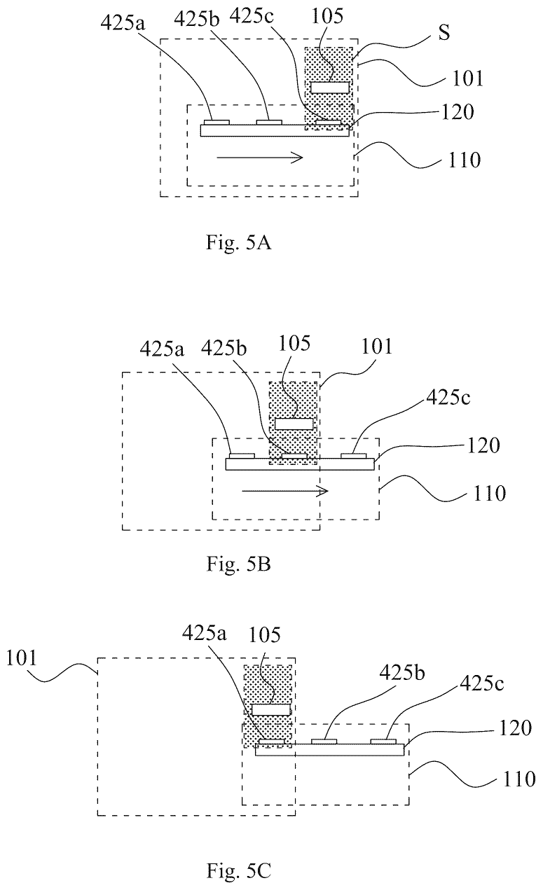

The handle system 100 further includes a position sensing device 120 (an enlarged dashed circle 103 in FIG. 1A illustrates the position sensing device 120) and a sensed member 105 (shown in more detail in FIGS. 5A-6C). The position sensing device 120 is communicatively connected to the control device 150. The position sensing device 120 is positioned on one of the handle seat 101 and the handle body 110, and the sensed member 105 is positioned on the other of the handle seat 101 and the handle body 110, such that the position sensing device 120 can move relative to the sensed member 105. The position sensing device 120 detects the relative positions of the sensed member 105 relative to the position sensing device 120, and send corresponding signals to the control device 150. The control device 150 determines the relative positions of the handle seat 101 and the handle body 110 based on detection signals. In the illustrated embodiment, the position sensing device 120 is encapsulated inside the handle body 110. The sensed member 105 is positioned on an inner wall of the handle seat 101. As an example, the second support post 112 of the handle body 110 is in a hollow shape and has a cavity 115, and the position sensing device 120 is encapsulated in the cavity 115 of the second support post 112 and close to the top of the second support post 112. The sensed member 105 is positioned on an inner side of the top wall of the handle seat 101.

In the illustrated embodiment, during the movement of the handle body 110 from the retracted position to the first deployed position, the first post 111 and the second post 112 of the handle body 110 synchronously perform the translational movement, and during the movement of the handle body 110 from the first deployed position to the second deployed position, the handle body 110 performs the rotational movement with the inner end of the first post 111 as the pivot point. Thus, compared with the first post 111, the second support post 112 has a travel distance greater than the travel distance of the first support post 111. Therefore, by positioning the position sensing device 120 on the second support post 112, the position of the handle body 110 can be reflected more accurately.

Those skilled in the art should understand that, in some embodiments, the position sensing device 120 may also be encapsulated on the right side of the second support post 112, and the sensed member 105 is correspondingly positioned on an inner side of a right sidewall of the handle seat 101.

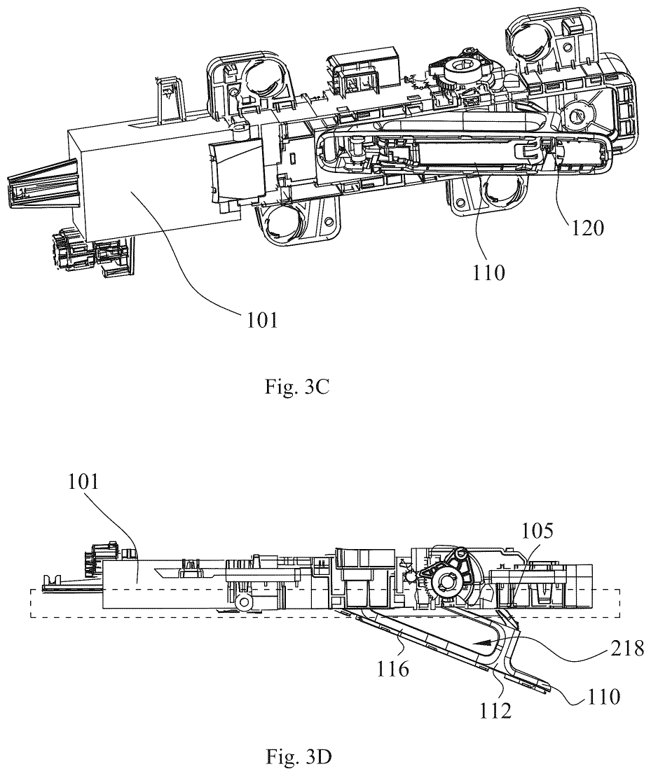

In some embodiments, the sensed member 105 has a sensed area S (see FIGS. 5A-6C). The position sensing device 120 includes at least two position sensors 425 (see FIGS. 4A and 4B). The at least two position sensors 425 are spaced apart in a movement direction of the handle body 110. When the relative position between the at least two position sensors 425 and the sensed member 105 is such that any one of the at least two position sensors 425 enters the sensed area S of the sensed member 105, the sensed member 105 can be detected by the position sensor that enters the sensed area S. When the relative position between the at least two position sensors 425 and the sensed member 105 is such that at least one position sensor 425 leaves the sensed region S of the sensed member 105, the sensed member 105 cannot be detected by the position sensor that leaves the sensed area S. Depending on whether the sensed member 105 is detected, each position sensor can send a corresponding detection signal indicating the position of the handle body 110 relative to the handle seat 101.

In this embodiment, the sensed member 105 is a magnet, and the sensed area S is a magnetic field of the magnet. Moreover, the position sensor 425 is a Hall sensor configured to detect the magnetic field of the magnet. In some more specific embodiments, the Hall sensor is a switch-type Hall sensor. The switch-type Hall sensor generates a low-level signal or high-level signal depending on whether the magnet is detected. In some specific embodiments, a low-level signal may be sent when the switch-type Hall sensor detects the magnet. A high-level signal may be sent when the switch-type Hall sensor does not detect the magnet. Compared with other detection devices, the Hall sensor has a smaller size while having a higher detection accuracy and is especially suitable for being encapsulated in a narrow space in the second support post 112 of the handle body 110. In other embodiments, the position sensor may be other types of position sensors.

In this way, by positioning the sensed member 105 and the at least two position sensors of the position sensing device 120 in corresponding positions, the control device 150 can determine whether the handle body 110 reaches the retracted position, the first deployed position or the second deployed position depending on whether the position sensors detect the sensed member 105. This will be described below in detail in conjunction with FIGS. 5A-5D and FIGS. 6A-6C. Those skilled in the art should understand that, in other embodiments, the sensed member 105 may be encapsulated inside the handle body 110, and thus the position sensing device 120 may be positioned on the inner wall of the handle seat 101 at a corresponding position.

FIGS. 4A and 4B illustrate a detailed structure of the position sensing device 120. FIG. 4A illustrates a structural perspective view of the position sensing device 120, and FIG. 4B illustrates an exploded view of the position sensing device 120. As shown in FIGS. 4A and 4B, the position sensing device 120 includes a housing 421 and a circuit board 422. The housing 421 is mounted to the inner side of a top wall of the second support post 112 of the handle body 110, for example, by means of adhesive bonding. The circuit board 422 is mounted in the housing 421. Each position sensor 425 is integrated on the circuit board 422, and the circuit board 422 connects each position sensor 425 to a power supply and the control device 150 to supply power to the position sensor 425, and outputs a detection signal generated by the position sensor 425 to the control device 150.

The housing 421 is in the shape of a hollow strip with a front opening. A length direction of the housing 421 is substantially the same as a length direction of the second post 112. The hollow housing 421 can conveniently accommodate the circuit board 422 and provide a certain heat dissipation space. The circuit board 422 is substantially in the shape of a rectangular plate, and the circuit board 422 is mounted into the housing 421 through the front opening of the housing 421. After a handle cover plate (not shown) is fitted on a front side of the handle body 110, the front opening of the housing 421 can be closed by the handle cover plate. In the illustrated embodiment, the length of the housing 421 is substantially equal to or slightly greater than the length of the circuit board 422. A pair of ribs 424 are provided on an inner side of each of a left sidewall and a right sidewall of the housing 421. The pair of ribs 424 extend in the length direction of the housing 421 and are spaced apart from each other in parallel in a height direction of the housing 421 by a distance that matches the thickness of the circuit board 422. In this way, the circuit board 422 can be inserted into the housing 421 through the front opening of the housing 421 until the circuit board abuts against a rear wall of the housing 421, and left and right side edges of the circuit board 422 can be engaged between the pair of ribs 424 of each sidewall of the housing 421, to ensure that the circuit board 422 cannot move relative to the housing 421. When the housing 421 is secured to the handle body 110, the circuit board 422 also cannot move relative to the handle body 110. In this embodiment, a notch 423 is formed in the bottom of the front side of the housing 421, and wires or lines connected to the circuit board 422 can pass through the notch 423 to allow a wire harness to be organized in a more orderly manner.

The position sensors 425 are integrated above the circuit board 422 to face the handle seat 101, thereby facilitating the detection of the sensed member 105 located on the inner side of the top wall of the handle seat 101. In the illustrated embodiment, the position sensing device 120 includes three position sensors, namely a first position sensor 425a, a second position sensor 425c and a third position sensor 425b. The first position sensor 425a, the third position sensor 425b and the second position sensor 425c are positioned spaced apart in a length direction of the circuit board 422. In addition, the three position sensors are also positioned spaced apart in the movement direction of the handle body 110. The second position sensor 425c is positioned outside the first position sensor 425a, and the third position sensor 425b is positioned between the second position sensor 425c and the first position sensor 425a.

The positions of the three position sensors are fixed relative to the handle body 110 when the circuit board 422 is stationary relative to the handle body 110. Therefore, depending on whether the position sensors 425 detects the sensed member 105 on the handle seat 101, the position of the handle body 110 relative to the handle seat 101 can be indicated. For example, it can be indicated whether the handle body 110 reaches the retracted position, the first deployed position or the second deployed position. The control device 150 determines the position of the handle body 110 according to signals sent by the three position sensors, and performs a corresponding action. For example, upon determining that the handle body 110 reaches the retracted position, the control device 150 controls the driving device 160 to stop driving the handle body 110 to retract. Upon determining that the handle body 110 reaches the first deployed position, the control device 150 controls the driving device 160 to stop driving the handle body 110 to deploy. Upon determining that the handle body 110 reaches the second deployed position, the control device 150 controls the electronic lock device 170 to unlock.

In some embodiments, the handle system 100 may further include a light module 438. The light module 438 is also integrated on the circuit board 422 and is turned on or off based on the position of the handle body 110. In some embodiments, the light module 438 includes an LED light, which is turned on when the handle body 110 is in the first deployed position and turned off when the handle body 110 is in the retracted position. In some embodiments, the light module 438 has different light colors when the handle body 110 is in different positions. By providing the light module 438, the handle system 100 can also has a lighting effect. Those skilled in the art should understand that the light module 438 can diffuse light by means of a light guide component, a lightshade, etc.

In the handle system 100 according to this embodiment, by providing the circuit board 442, the at least two position sensors can be integrated to one single circuit board 422, so that the handle system not only has sufficient detection accuracy, but also reduces the layout space for the position sensors.

FIGS. 5A-5D illustrate simplified schematic views showing relative positions of the handle seat 101 and the handle body 110 during the movement of the handle body 110 of the handle system according to an embodiment of the present disclosure, for illustrating the position sensing principle of the position sensing device 120. To show the relative positions of the sensed member 105 and the position sensing device 120, FIGS. 5A-5D show the relative positions of the handle seat 101 and the handle body 110 of the handle system 100 in FIGS. 1A-1B substantially as viewed from the left side. From this perspective, the handle body 110 is moved from inside to outside relative to the handle seat 101, that is, from left to right as shown in FIGS. 5A-5D. In the embodiment shown in FIGS. 5A-5D, the position sensing device includes three position sensors. The control device 150 determines that the handle body 110 reaches the first deployed position based on the detection signal from the first position sensor 425a, determines that the handle body 110 reaches the retracted position based on the detection signal from the second position sensor 425c, and determines that the handle body 110 reaches the second deployed position jointly based on the detection signals from the first position sensor 425a, the second position sensor 425c, and the third position sensor 425b.

FIG. 5A illustrates the relative positions of the handle seat 101 and the handle body 110 with the handle body 110 in the retracted position. FIG. 5B illustrates the relative positions of the handle seat 101 and the handle body 110 during the movement of the handle body 110 from the retracted position to the first deployed position. FIG. 5C illustrates the relative positions of the handle seat 101 and the handle body 110 with the handle body 110 in the first deployed position. FIG. 5D illustrates the relative positions of the handle seat 101 and the handle body 110 with the handle body 110 in the second deployed position. Table 1 illustrates detection signals sent by the position sensors of the position sensing device in FIGS. 5A-5D. In this embodiment, the detection signals include a first signal and a second signal sent by the first position sensor 425a, a third signal and a fourth signal sent by the second position sensor 425c, and a fifth signal and a sixth signal sent by the third position sensor 425b.

TABLE 1
Detection signals sent by position sensors

| | First position | Third position | Second position |
|---|---|---|---|
| | sensor 425a | sensor 425b | sensor 425c |
| Retracted position (FIG. 5A) | Second signal | Sixth signal | Third signal (low |
| | (high level) | (high level) | level) |
| From the retracted position to the | Second signal | Fifth signal (low | Fourth signal |
| first deployed position (FIG. 5B) | (high level) | level) | (high level) |
| First deployed position (FIG. 5C) | First signal (low | Sixth signal | Fourth signal |
| | level) | (high level) | (high level) |
| Second deployed position (FIG. 5D) | Second signal | Sixth signal | Fourth signal |
| | (high level) | (high level) | (high level) |

As shown in FIG. 5A, the handle body 110 is in the retracted position. The handle body 110 is generally within in the handle seat 101 as shown in FIG. 1B. The handle body 110 is in the leftmost position (i.e., the uppermost position in FIG. 1B) relative to the handle seat 101. In this case, the second position sensor 425c positioned outermost (i.e., rightmost in FIGS. 5A-5C) of the position sensing device 120 is in the sensed area S of the sensed member 105, so that the second position sensor 425c can detect the sensed member 105 and generate the third signal. The third signal is a low-level signal. The first position sensor 425a and the third position sensor 425b are not in the sensed area S, so that neither of the first position sensor and the third position sensor detects the sensed member 105. The first position sensor 425a generates the second signal, and the third position sensor 425b generates the sixth signal. The second signal and the sixth signal are high-level signals.

When the handle body 110 is moved rightward from the retracted position to the first deployed position in a direction shown by the arrow in FIG. 5A, the second position sensor 425c moves out of the sensed area S of the sensed member 105 until the second position sensor reaches the position shown in FIG. 5B.

As shown in FIG. 5B, the handle body 110 is leaves the retracted position thereof, but has not yet reached the first deployed position thereof. At this moment, the third position sensor 425b in the middle of the position sensing device 120 is in the sensed area S of the sensed member 105, so that the third position sensor 425b can detect the sensed member 105 and generate the fifth signal. The fifth signal is a low-level signal. However, the first position sensor 425a and the second position sensor 425c are not in the sensed area S, so that neither of the first position sensor and the second position sensor detects the sensed member 105, the first position sensor 425a generates the second signal, and the second position sensor 425c generates the fourth signal. The second signal and the fourth signal are high-level signals.

As the handle body 110 continues to be moved rightward to the first deployed position relative to the handle seat 101 in a direction shown by the arrow in FIG. 5B, the third position sensor 425b also gradually moves out of the sensed area S of the sensed member 105 until the handle body 110 reaches the first deployed position as shown in FIG. 5C.

As shown in FIG. 5C, the handle body 110 is in the first deployed position. The handle body 110 is predominantly located outside the handle seat 101. At this moment, the first position sensor 425a positioned leftmost the position sensing device 120 is in the sensed area S of the sensed member 105, so that the first position sensor 425a can detect the sensed member 105 and generate the first signal. The first signal is a low-level signal. However, both the third position sensor 425b and the second position sensor 425c move out of the sensed area S, so that neither of the third position sensor and the second position sensor detects the sensed member 105. The third position sensor 425b generates the sixth signal, and the second position sensor 425c generates the fourth signal. The sixth signal and the fourth signal are high-level signals. In some embodiments, the handle body 110 may even be located substantially completely outside the handle seat 101 as shown in FIG. 2B, as long as the first position sensor 425a is still in the sensed area S of the sensed member 105.

When the operator pulls the handle body 110 in the position shown in FIG. 5C, the handle body 110 continues to be moved rightward relative to the handle seat 101, all the position sensors of the position sensing device 120 move out of the sensed area S of the sensed member 105, and the handle body 110 reaches the second deployed position as shown in FIG. 5D.

As shown in FIG. 5D, the handle body 110 reaches the second deployed position. The second support post 112 of the handle body 110 is located completely outside the handle seat 101. At this moment, the position sensing device 120 is also located completely outside the handle seat 101, all the position sensors move out of the sensed area S of the sensed member 105, so that none of the position sensors detects the sensed member 105. The first position sensor 425a generates the second signal, the third position sensor 425b generates the sixth signal, and the second position sensor 425c generates the fourth signal. The second signal, the sixth signal and the fourth signal are all high-level signals.

Therefore, when the handle body 110 is in different positions relative to the handle seat 101, the three position sensors of the position sensing device 120 can generate different detection signals to indicate the position of the handle body 110. Accordingly, the control device 150 can determine the position of the handle body 110 based on the detection signals sent by the three position sensors of the position sensing device 120. In this embodiment, the control device 150 determines based on the third signal that the handle body 110 reaches the retracted position, and determines based on the first signal that the handle body 110 reaches the first deployed position. The control device 150 can also determine based on the second signal, the fourth signal and the sixth signal that the handle body 110 reaches the second deployed position.

In this embodiment, since the handle body 110 has a relatively long travel distance from the retracted position to the first deployed position, the position sensing device 120 is provided with three position sensors positioned spaced apart to ensure that the position where none of the position sensors detects the sensed member is the second deployed position of the handle body, rather than a position of the handle body between the retracted position and the first deployed position. In some other embodiments, the position sensing device 120 may include only the first position sensor 425a and the second position sensor 425c when the handle body 110 has a relatively short travel distance from the retracted position to the first deployed position.

FIGS. 6A-6C illustrate simplified schematic views showing the relative positions of the handle seat 101 and the handle body 110 during the movement of the handle body 110 of the handle system according to another embodiment of the present disclosure. Similar to FIGS. 5A-5D, FIGS. 6A-6C illustrate the relative positions of the handle seat 101 and the handle body 110 of the handle system 100 in FIGS. 1A-1B substantially as viewed from the left side. From this perspective, the handle body 110 is moved from inside to outside relative to the handle seat 101, that is, from left to right as shown in FIGS. 6A-6C. In the embodiment shown in FIGS. 6A-6C, the position sensing device 620 includes only two position sensors, namely the first position sensor 425a and the second position sensor 425c. The control device 150 determines that the handle body 110 reaches the first deployed position based on the detection signal from the first position sensor 425a, determines that the handle body 110 reaches the retracted position based on the detection signal from the second position sensor 425c, and determines that the handle body 110 reaches the second deployed position jointly based on the detection signals from both the first position sensor 425a and the second position sensor 425c.

FIG. 6A illustrates the relative positions of the handle seat 101 and the handle body 110 with the handle body 110 in the retracted position. FIG. 6B illustrates the relative positions of the handle seat 101 and the handle body 110 with the handle body 110 in the first deployed position. FIG. 6C illustrates the relative positions of the handle seat 101 and the handle body 110 with the handle body 110 in the second deployed position. Table 2 illustrates detection signals sent by the detection sensors of the position sensing device in the process shown in FIGS. 6A-6C. In this embodiment, the detection signals include a first signal and a second signal sent by the first position sensor 425a, and a third signal and a fourth signal sent by the second position sensor 425c.

TABLE 2
Detection signals sent by position sensors

| | First position | Second position sensor |
|---|---|---|
| | sensor 425a | 425c |
| Retracted position | Second signal | Third signal (low level) |
| (FIG. 6A) | (high level) | |
| First deployed position | First signal | Fourth signal (high level) |
| (FIG. 6B) | (low level) | |
| Second deployed position | Second signal | Fourth signal (high level) |
| (FIG. 6C) | (high level) | |
| | First position | Second position sensor |
| | sensor 425a | 425c |

As shown in FIG. 6A, the handle body 110 is in the retracted position. In this case, the second position sensor 425c positioned outermost of the position sensing device 120 is in the sensed area S of the sensed member 105, so that the second position sensor 425c can detect the sensed member 105 and generate the third signal. However, the first position sensor 425a is not in the sensed area S, so that the first position sensor 425a does not detect the sensed member 105 and generates the second signal. The third signal is a low-level signal, and the second signal is a high-level signal.

When the handle body 110 is moved rightward from the retracted position to the first deployed position in a direction shown by the arrow in FIG. 6A, the second position sensor 425c gradually moves out of the sensed area S of the sensed member 105 until the handle body 110 reaches the first deployed position shown in FIG. 6B.

As shown in FIG. 6B, the handle body 110 is in the first deployed position. At this moment, the first position sensor 425a positioned leftmost of the position sensing device 620 is in the sensed area S of the sensed member 105, so that the first position sensor 425a can detect the sensed member 105 and generate the first signal. However, the second position sensor 425c moves out of the sensed area S, so that the second position sensor 425c does not detect the sensed member 105 and generates the fourth signal. The first signal is a low-level signal, and the fourth signal is a high-level signal.

When the operator pulls the handle body 110 in the position shown in FIG. 6B, the handle body 110 continues to be moved rightward relative to the handle seat 101, both position sensors of the position sensing device 620 move out of the sensed area S of the sensed member 105, and the handle body 110 reaches the second deployed position as shown in FIG. 6C.

As shown in FIG. 6C, the handle body 110 reaches the second deployed position. The second support post 112 of the handle body 110 is located completely outside the handle seat 101. At his moment, the position sensing device 620 is also located completely outside the handle seat 101, both position sensors move out of the sensed area S of the sensed member 105, so that neither of the position sensors detects the sensed member 105. The first position sensor 425a generates the second signal, and the second position sensor 425c generates the fourth signal. Both the second signal and the fourth signal are high-level signals.

Therefore, when the handle body 110 is in different positions relative to the handle seat 101, the two position sensors of the position sensing device 620 can generate different detection signals to indicate the position of the handle body 110. Accordingly, the control device 150 can determine the position of the handle body 110 based on the detection signals sent by the two position sensors of the position sensing device 620. In this embodiment, the control device 150 determines based on the third signal that the handle body 110 reaches the retracted position, and determines based on the first signal that the handle body 110 reaches the first deployed position. The control device 150 can also determine based on the second signal and the fourth signal that the handle body 110 reaches the second deployed position.

The difference between the embodiment shown in FIGS. 5A-5D and the embodiment shown in FIGS. 6A-6C lies in that the position sensing device includes a different number of position sensors. In the embodiment shown in FIGS. 5A-5D, the handle body 110 has a relatively long travel distance from the retracted position to the first deployed position, while the sensing range S of the sensed member 105 is relatively small, so if the third position sensor 425b is not included, when the handle body 110 is in the position shown in FIG. 5B and in the position shown in FIG. 5D, the detection signals received by the control device are the second signal and the fourth signal in both cases, resulting in failure of the recognition of the second deployed position. Those skilled in the art can set a corresponding number of Hall sensors according to the travel distance of the handle body 110 from the retracted position to the first deployed position and a detection range of the Hall sensors.

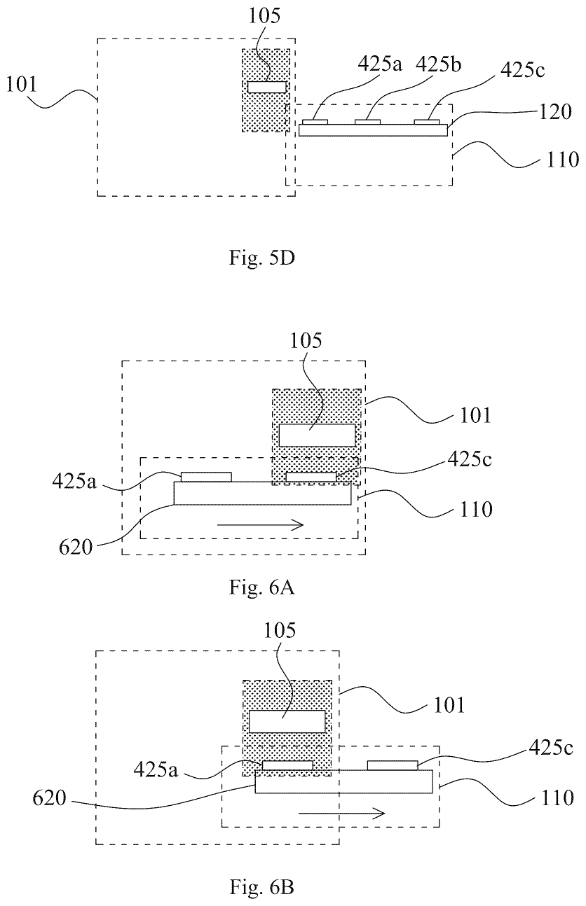

FIG. 7 illustrates a connection block diagram of the control device 150, the position sensing device 120, the driving device 160 and the electronic lock device 170. As shown in FIG. 7, the position sensing device 120, the control device 150 and the driving device 160 of the handle system 100 are communicatively connected to the electronic lock device 170 of the door 107 of the vehicle, to enable the control device 150 to receive the detection signals sent by the position sensing device 120, to control the driving device 160 based on the received detection signals, and to control the unlocking of the electronic lock device 170.

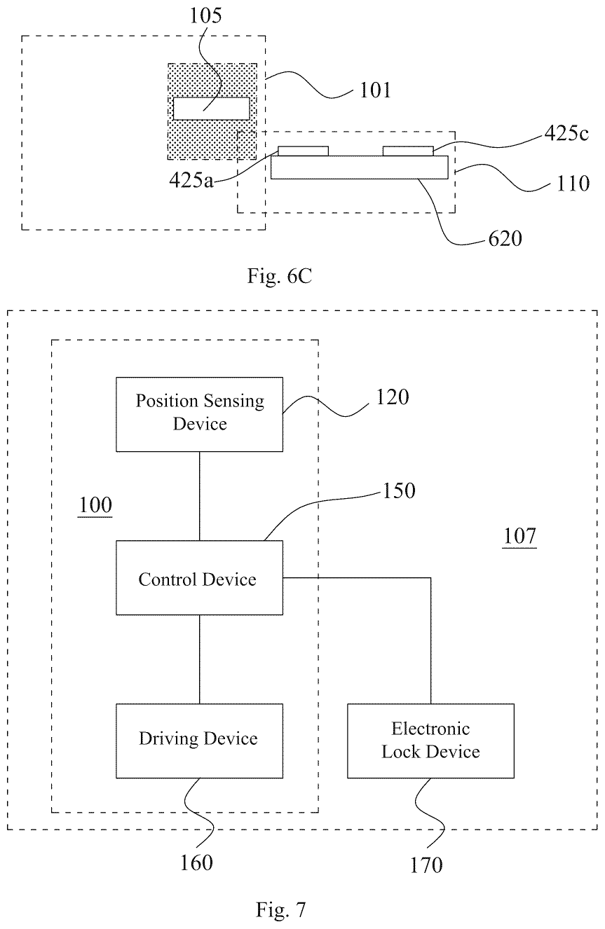

FIG. 8 illustrates a simplified circuit diagram of a detection circuit 831 on the circuit board 422 in the embodiment shown in FIG. 4A.

As shown in FIG. 8, the detection circuit 831 includes a power supply terminal 832 and a ground terminal 833. The power supply terminal 832 is in communication with the control device 150 and is connected to a power supply via the control device 150 for supplying a voltage, for example, of 5 V to the detection circuit 831. The ground terminal 833 is grounded. The detection circuit 831 further includes a first circuit path 841, a second circuit path 842 and a third circuit path 843. The first circuit path 841, the second circuit path 842 and the third circuit path 843 are connected in parallel between the power supply terminal 832 and the ground terminal 833. The first position sensor 425a is connected in the first circuit path 841, the third position sensor 425b is connected in the second circuit path 842, and the second position sensor 425c is connected in the third circuit path 843.

The detection circuit 831 further includes three signal output terminals, namely, a signal output terminal 834, a signal output terminal 835 and a signal output terminal 836, which are all communicatively connected to the control device 150, to respectively output respective detection signals generated by the first position sensor 425a, the third position sensor 425b and the second position sensor 425c of the position sensing device 120 to the control device 150. In some embodiments, the first position sensor 425a and a resistor 837a are connected in series in the first circuit path 841, and the signal output terminal 834 is connected to the first circuit path 841 between the first position sensor 425a and the resistor 837a. The third position sensor 425b and a resistor 837b are connected in series in the second circuit path 842, and the signal output terminal 835 is connected to the second circuit path 842 between the third position sensor 425b and the resistor 837b. The second position sensor 425c and a resistor 837c are connected in series in the third circuit path 843, and the signal output terminal 836 is connected to the third circuit path 843 between the second position sensor 425c and the resistor 837c. After the first circuit path 841, the second circuit path 842 and the third circuit path 843 are connected in parallel, one end is connected to the ground terminal 833, and the other end is connected to the power supply terminal 832.

The light module 438 has one end connected to the control device 150 via an LED port 837, and the other end connected to the ground terminal 733. In this way, the control device 150 controllably supplies power to the light module 438, so that the handle system 100 can have a lighting effect.

Therefore, only by connecting the circuit board 422 to the control device 150 via the power supply terminal 832, the signal output terminal 834, the signal output terminal 835, the signal output terminal 836 and the LED port 837, the position of the handle body 110 of the handle system 100 can be determined and the light module 438 of the handle system 100 can be controlled.

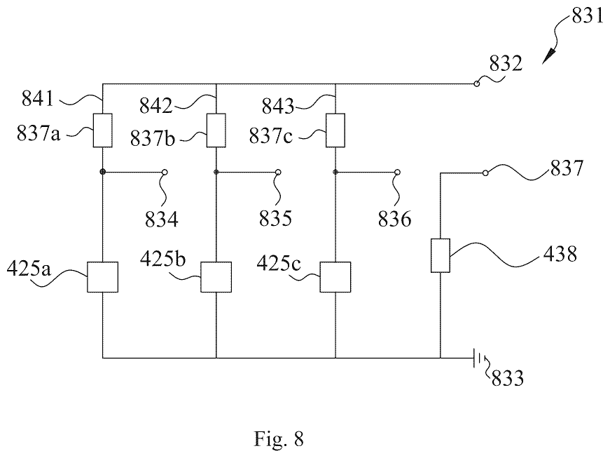

FIG. 9 illustrates a structural block diagram of the control device of the door handle system. As shown in FIG. 9, the control device 150 includes a bus 951, a processor 952, an input interface 953, an output interface 954, and a memory 955 having a program 956. The components in the control device 150, including the processor 952, the input interface 953, the output interface 954 and the memory 955, are communicatively connected to the bus 951, such that the processor 952 can control operations of the input interface 953, the output interface 954 and the memory 955. Specifically, the memory 955 is configured to store programs, instructions and data, and the processor 952 reads the programs, instructions and data from the memory 955 and can write data to the memory 955. The processor 952 controls the operations of the input interface 953 and the output interface 954 by means of executing the programs and the instructions read from the memory 955.

As shown in FIG. 9, the input interface 953 is communicatively connected to the signal output terminals of the position sensing device 120 and various input instructions by means of a connection line 957, to receive various parameters such as the detection signals of the handle system 100 or input parameters operated by the operator, and to store these parameters in the memory 955. The output interface 954 is communicatively connected to the driving device 160 of the handle system 100, the electronic lock device 170 of the door 107, the power supply terminal and the LED port by means of a connection line 958. By executing the program 956 in the memory 955, the control device 150 controls the movement of the driving device 160 of the handle system, and the electronic lock device 170 and turns on or off the light module 438. For example, the input interface 953 is communicatively connected to the signal output terminal 834, the signal output terminal 835 and the signal output terminal 836 of the circuit board 422 to receive the detection signals of the handle system 100. Based on the received detection signals, the processor 952 generates a corresponding control instruction according to the program 956 in the memory 955, including a control instruction for the driving device 160, an unlocking instruction for the electronic lock device 170 and an on/off instruction for the light module 438. By means of the output connection line 958, the control device 150 sends out the generated control instruction through the power supply terminal 832 of the circuit board 422, the LED port 837, the electronic lock device 170, etc. Of course, those skilled in the art should appreciate that signals received by the input interface 953 are not limited to the detection signals, and the control instructions generated by the processor 952 are also not limited to the above instructions.

FIG. 10 illustrates a schematic diagram of a vehicle including the handle system 100 shown in FIG. 1A. As shown in FIG. 10, the vehicle 1060 comprises the door 107, the electronic lock device 170, and the handle system 100. The electronic lock device 170 is positioned on the door 107 for locking or unlocking the door 107. The handle system 100 can control the electronic lock device 170 and/or the driving device 160 based on the position of the handle body relative to the handle seat.

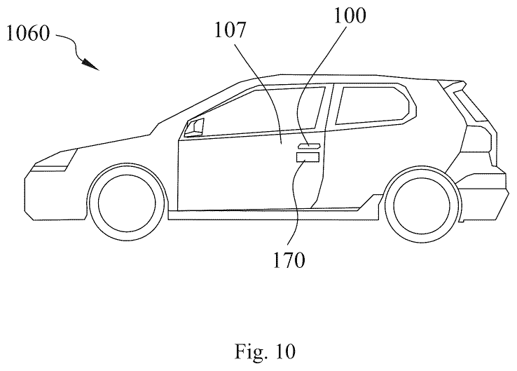

FIG. 11 illustrates a flowchart of the method for controlling the handle system 100. As shown in FIG. 11, the method for controlling the handle system 100 includes step 1161, step 1162, and step 1163. In step 1161, the control device 150 detects the relative position of the sensed member 105 relative to the position sensors 425 via the position sensors 425. For example, the control device 150 detects via the position sensors 425 whether the position sensors enter the sensed region S of the sensed member 105, and the position sensors 425 can generate corresponding detection signals. Step 1162 is then executed.

In step 1162, the control device 150 determines the position of the handle body relative to the handle seat based on the detection signals received from the position sensors 425. Step 1163 is then executed.

In step 1163, based on the position of the handle body relative to the handle seat, the control device 150 controls the operation of the driving device 160 or controls the operation of the electronic lock device 170. For example, it controls the driving device 160 to stop driving the handle body 110 to retract, to stop driving the handle body 110 to deploy, or controls the electronic lock device 170 to unlock.

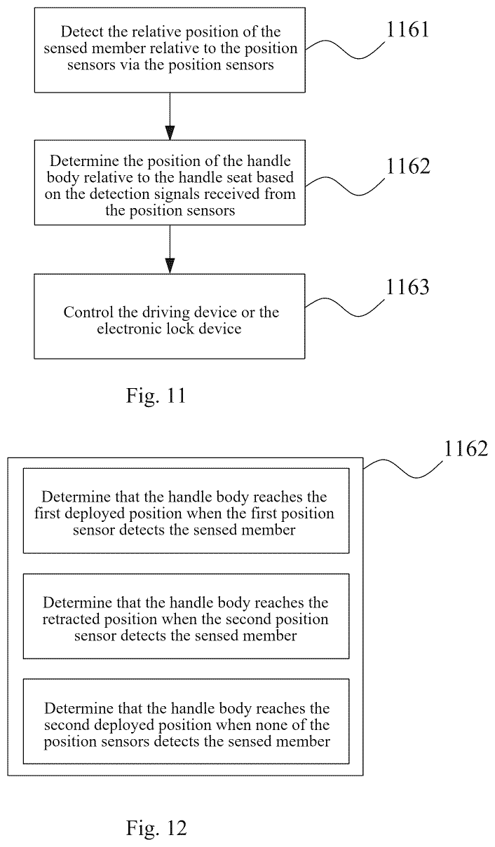

FIG. 12 illustrates the step 1162 in FIG. 11. As shown in FIG. 12, step 1162 includes: when the first position sensor 425a detects the sensed member 105, it is determined that the handle body 110 reaches the first deployed position relative to the handle seat 101; when the second position sensor 425c detects the sensed member 105, it is determined that the handle body 110 reaches the retracted position relative to the handle seat 101; and when none of the position sensors detects the sensed member 105, it is determined that the handle body 110 reaches the second deployed position relative to the handle seat 101.

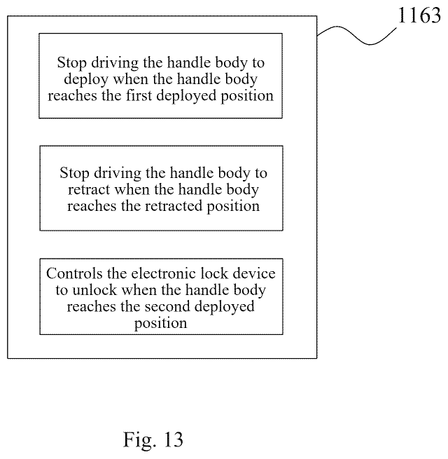

FIG. 13 illustrates the step 1163 in FIG. 11. As shown in FIG. 13, step 1163 includes: when the handle body 110 reaches the first deployed position relative to the handle seat 101, the control device 150 controls the driving device 160 to stop driving the handle body 110 to deploy; when the handle body 110 reaches the retracted position relative to the handle seat 101, the control device 150 controls the driving device 160 to stop driving the handle body 110 to retract; and when the handle body 110 reaches the second deployed position relative to the handle seat 101, the control device 150 controls the electronic lock device 170 to unlock.

The handle system of the present disclosure can accurately indicate that the handle body is in the retracted position, the first deployed position or the second deployed position relative to the handle seat by providing the position sensing device and sensed member, which cooperatively work, on the handle seat and the handle body. Based on the position of the handle body, the control device of the handle system can control the driving device, such that the driving device stops driving the handle body when the handle body is moved to the retracted position and the first deployed position, and the control device can control the unlocking of the electronic lock device when the handle body is moved to the second deployed position.

The handle system of the present disclosure does not require additional components on the driving device, such as an extra counter or the like, to indicate whether the driving device has driven the handle body into position, nor additional micro-switches that require mechanical actuation to open or close for indicating the position of the handle body to control the unlocking of the electronic lock device. Consequently, additional components communicatively connected to the control device can be omitted.

The position sensing device of the present disclosure can be positioned inside the handle body, and the sensed member is positioned inside the handle seat, so that the waterproof performance and durability are good, and the reliability is higher.

In some embodiments, the sensed member is a magnet, and the position sensing device includes at least two Hall sensors. The size and the detection accuracy of the Hall sensors are more suitable for position detection of the flush handle system due to the limited internal dimensions of the handle body. Based on the travel distance of the handle body, the Hall sensors can also cover the entire travel distance of the handle body by setting the number of Hall sensors.

Furthermore, since the position sensing device of the present disclosure is integrated with lines by means of the circuit board, the integration performance is good, and one ground terminal can also be shared on the circuit board even if additional functional modules such as the LED module are included. Therefore, the number of ports can also be decreased, the wiring and routing of the handle system can be simplified, the lines are more organized, and the assembly is more convenient.

While the present disclosure has been described in conjunction with the examples of embodiments outlined above, various alternatives, modifications, variations, improvements and/or substantial equivalents, whether known or that are or may be presently foreseen, may become apparent to those having at least ordinary skill in the art. The technical effects and technical problems in the specification are exemplary and are not limiting. It should be noted that the embodiments described in the specification may have other technical effects and can solve other technical problems. Accordingly, the examples of embodiments of the present disclosure, as set forth above, are intended to be illustrative, not limiting. Various changes may be made without departing from the spirit or scope of the invention. Therefore, the present disclosure is intended to embrace all known or earlier developed alternatives, modifications, variations, improvements and/or substantial equivalents.

### MAIN REFERENCE SIGNS

100 Handle system
101 Handle seat
105 Sensed member
1060 Vehicle
107 Door
110 Handle body
111 First support post
112 Second support post
115 Cavity
116 Grip portion
120 Position sensing device
150 Control device
160 Driving device
170 Electronic lock device
213 First link
214 Second link
218 Accommodating cavity
421 Housing
422 Circuit board
423 Notch
424 Rib
425 Position sensor
425a First position sensor
425b Third position sensor
425c Second position sensor
438 Light module
620 Position sensing device
733 Ground terminal
831 Detection circuit
832 Power supply terminal
833 Ground terminal
834 Signal output terminal
835 Signal output terminal
836 Signal output terminal
837 LED port
837a Resistor
837b Resistor
837c Resistor
841 First circuit path
842 Second circuit path
843 Third circuit path
951 Bus
952 Processor
953 Input interface
954 Output interface
955 Memory
956 Program
957 Connection line
958 Connection line

What is claimed is:

1. A handle system for a door of a vehicle having an electronic lock device, the handle system comprising:
a handle seat;
a handle body mounted to the handle seat and movable relative to the handle seat between a retracted position, a first deployed position and a second deployed position;
a driving device configured to drive the handle body to deploy from the retracted position to the first deployed position and to retract from the first deployed position to the retracted position;
a position sensing device comprising at least two position sensors positioned on one of the handle seat and the handle body and spaced apart in a movement direction of the handle body;
a sensed member positioned on the other of the handle seat and the handle body and having a sensed area, the sensed member being configured such that when any one of the at least two position sensors enters the sensed region, the sensed member is detected by the position sensor entering the sensed region;
a control device communicatively connected to the position sensing device, the driving device, and the electronic lock device,
wherein the control device is configured to determine whether the handle body reaches the retracted position, the first deployed position or the second deployed position depending on whether the at least two position sensors detect the sensed member, to control the driving device to stop driving the handle body to retract when determining that the handle body reaches the retracted position, to control the driving device to stop driving the handle body to deploy when determining that the handle body reaches the first deployed position, and to control the electronic lock device to unlock when determining that the handle body reaches the second deployed position.

2. The handle system according to claim 1, wherein the at least two position sensors comprise a first position sensor and a second position sensor, the second position sensor being positioned outermost and the first position sensor being positioned innermost in the movement direction of the handle body;
wherein when the handle body reaches the retracted position, the second position sensor detects the sensed member;
when the handle body reaches the first deployed position, the first position sensors detects the sensed member; and
when the handle body reaches the second deployed position, none of the at least two position sensors detects the sensed member.

3. The handle system according to claim 2, wherein the control device determines that the handle body reaches the retracted position based on a detection signal from the second position sensor, determines that the handle body reaches the first deployed position based on a detection signal from the first position sensor, and determines that the handle body reaches the second deployed position based on detection signals from both the first position sensor and the second position sensor.

4. The handle system according to claim 2, wherein the at least two position sensors further comprise a third position sensor, the third position sensor being positioned between the first position sensor and the second position sensor; and
wherein the control device determines that the handle body reaches the retracted position based on a detection signal from the second position sensor, determines that the handle body reaches the first deployed position based on a detection signal from the first position sensor, and determines that the handle body reaches the second deployed position based on detection signals from all of the first position sensor, the second position sensor and the third position sensor.

5. The handle system according to claim 1, wherein the position sensors are Hall sensors; and
wherein the sensed member is a magnet, and the sensed area is a magnetic field of the magnet.

6. The handle system according to claim 5, wherein the Hall sensors are switch-type Hall sensors.

7. The handle system according to claim 5, wherein the position sensing device further comprises a circuit board, the at least two position sensors being integrated on the circuit board, and the circuit board having a power supply terminal for connecting the at least two position sensors to a power supply, and signal output terminals for connecting the at least two position sensors to the control device.

8. The handle system according to claim 7, wherein the position sensing device further comprises a housing, the circuit board being accommodated and retained in the housing.

9. The handle system according to claim 7, further comprising a light module, the light module being integrated on the circuit board and being turned on or off based on the position of the handle body.

10. The handle system according to claim 1, wherein the sensed member is positioned on an inner wall of the handle seat, and the at least two position sensors are encapsulated inside the handle body.

11. The handle system according to claim 10, wherein the handle body has a grip portion, and a first support post and a second support post on two opposite sides of the grip portion;
wherein a travel distance of the second support post is greater than a travel distance of the first support post during movement from the retracted position to the second deployed position; and
wherein the position sensing device is encapsulated inside the second support post of the handle body.

12. A vehicle, comprising:
a door;
an electronic lock device positioned on the door and configured to lock or unlock the door; and
a handle assembly according to any one of claim 1.

13. A method for controlling a handle system, the handle system comprising a sensed member, at least two position sensors, a handle body, a handle seat, and a driving device, the sensed member being positioned on one of the handle body and the handle seat, and the at least two position sensors being positioned on the other of the handle body and the handle seat, the method comprising:
detecting a relative position of the sensed member relative to the at least two position sensors via the at least two position sensors;
determining a position of the handle body relative to the handle seat depending on detection signals obtained from the at least two position sensors; and
controlling the driving device to stop driving the handle body to retract, stop driving the handle body to deploy, or controlling an electronic lock device to unlock, depending on the position of the handle body relative to the handle seat.

14. The method according to claim 13, wherein the step of determining the position of the handle body relative to the handle seat based on the detection signals obtained from the at least two position sensors comprises:
when a first position sensor, positioned innermost in a movement direction of the handle body among the at least two position sensors, detects the sensed member, determining that the handle body reaches a first deployed position;
when a second position sensor, positioned outermost in the movement direction of the handle body among the at least two position sensors, detects the sensed member, determining that the handle body reaches a retracted position; and
when none of the at least two position sensors detects the sensed member, determining that the handle body reaches a second deployed position.

15. The method according to claim 14, wherein the step of controlling the driving device to stop driving the handle body to retract, stop driving the handle body to deploy, or controlling the electronic lock device to unlock based on the position of the handle body relative to the handle seat comprises:
when the handle body reaches the first deployed position, stopping driving the handle body to deploy;
when the handle body reaches the retracted position, stopping driving the handle body to retract; and
when the handle body reaches the second deployed position, controlling the electronic lock device to unlock.
